(19) United States
(12) Patent Application Publication
(10) Pub. No.: US 2021/0227989 A1
(43) Pub. Date: Jul. 29, 2021

(54) A SPRING SYSTEM AND METHOD FOR PRODUCTION OF SPRING SYSTEM

(71) Applicant: ZEB METAL SANAYI IÇ VE DIS TICARET LIMITED SIRKETI, Kayseri (TR)

(72) Inventor: Abdurrahim AYKAS, Kayseri (TR)

(21) Appl. No.: 16/769,094

(22) PCT Filed: Mar. 12, 2019
(86) PCT No.: PCT/TR2019/050157

§ 371 Date: Jun. 2, 2020

(30) Foreign Application Priority Data
Jul. 5, 2018 (TR) 2018/09582

(51) Int. Cl. A47C 27/06

(52) U.S. Cl. CPC A47C 27/062; A47C 27/064; F16F 2228/001; F16F 2226/04; F16F 2226/042; F16F 2224/0208

(57) ABSTRACT

A spring unit containing a spring system used in bed, armchair and sofa like constructions and realizing different hardness and comfort levels in different areas of the constructions and having a soft spring forming a soft comfort area of low hardness of the spring unit, a medium hard spring providing gradual transition between soft comfort areas of the spring unit and hard comfort areas with a spring a having number of convolution different from the soft spring and of the same wire diameter, and a hard spring providing hard comfort area of the spring unit by a spring having number of convolution different from the soft spring and medium hard spring and of the same wire diameter as the medium hard spring and soft spring.

### RELATED ART

The invention relates to a new pocket spring system for sleeping or seat group products such as bed, bed base, sofa etc., and method for production of the spring system.

### PRIOR ART

Our spine is in the status of roof for our body. Being under load at office, school and work all day, it is very important to get it rest for our general health status.

Sleeping is the most needed thing for resting body. Body stores energy during sleeping, metabolism slows down and body rests. If a person does not lay down on a bed matching his/her physical status, body will not be able to get rest as needed.

Today when selecting bed, the most important thing to be taken into consideration is to prefer a bed of hardness and softness giving comfort proper for body. Bed comfort needed by a person depends on his/her type of body and sleeping positions and also it is essential to support different parts of body at proper comfort values as parts of body have different point weight.

Main filling material of bed is spring and steel spring mechanism is used to provide support for body and give flexibility to bed. Springs made from steel in the current most widely used system are attached to a steel upper layer called spring unit. In addition to said steel structure, comfort increasing foam, fibers and similar filling layers and support foams called wedge to prevent deformation are filled. Foam beds have foam plates of varying density as main filling material. The outside of beds is coated with a bed garment called quilting and layers consisting of soft fibers.

Pocket spring units are produced by gluing spring strips made from steel wire located inside nonwoven garment from top and bottom of strips by use of additional bottom and/or top nonwoven, from centre at contact points of nonwoven garment or from both centre and bottom and top by nonwoven with hot melted glue at spring assembly machines. In the prior art pocket spring units can be produced in a manner giving same hardness/comfort level in all areas of unit by use of single wire diameter and can also be produced in a manner giving different hardness/comfort level in different areas of unit by use of more than one different wire diameter in order to provide different hardness/comfort levels to different areas of body.

In pocket spring units produced in a manner to provide different hardness/comfort levels in different areas of carcass by use of more than one different wire diameter in order to ensure compatibility to body lines, since different comfort areas are obtained by use of springs made from different wire diameters for different comfort areas, hardness/comfort differences sensible sharply during transition from one comfort area to other.

Thus embodiment to obtain different comfort areas by use of springs made from wires of different diameters in the unit produced to make pocket spring unit more ergonomics causes a separate ergonomy problem because of spot sensible hardness/comfort transitions between comfort areas.

In the prior art the utility model numbered TR 2013/02121 relates to spring bed system with developed additional air space and it is characterized in that it consists of first air space, second air space, third air space, nonwoven and springs. However, said invention may cause cases endangering person's spine and comfort that may result from slide of springs subject to air spaces used to provide comfort and amount of bed use.

### PURPOSE OF THE INVENTION

Main purpose of invention is to have pocket spring system providing different hardness and comfort levels at different areas without use of wires of different diameter in spring production to be used in construction of bed, seats and sofa of similar constructions, and a method for production of spring system.

Another purpose of the invention is to eliminate problem of sharply sensible transition hardness/comfort level between different comfort areas in the spring unit of current methods.

A further purpose of the invention is to provide a pocket spring system more suitable to body contours and more ergonomics, providing gradual and softer transition between comfort areas.

Another purpose of the invention is to change order of spring assembling in different comfort zone spring unit production and thus shorten period of assembling operation and achieve process cost advantage.

A further purpose of the invention is to obtain a harder comfort zone, without use of spring with thicker wire diameter and achieve a spring system having one single wire diameter for different comfort zones.

In order to achieve above purposes, the invention is a pocket spring unit containing a spring system used in bed, armchair and sofa like constructions and realizing different hardness and comfort levels in different areas of said constructions and consisting of at least a soft spring forming soft comfort area of low hardness area of said spring unit, at least a spring of medium hardness providing gradual transition between soft comfort areas of said spring unit and hard comfort areas with a spring having number of convolution different from said soft spring and of same wire diameter, at least a hard spring providing hard comfort area of said spring unit by means of a spring having number of convolution different from spring of soft hardness and medium hardness and of same wire diameter as said medium hard spring and said soft spring.

In order to achieve above purposes, it is a spring unit consisting of at least a medium hard spring having number of convolution smaller than soft spring and bigger than hard spring and can be in range from 6 to 11.

In order to achieve above purposes, it is a spring unit consisting of at least a medium hard spring made from steel material.

In order to achieve above purposes, it is a spring unit consisting of at least a soft hardness spring having number of convolution bigger than medium hard spring and hard spring and that can be in range from 7 to 12.

In order to achieve above purposes, it is a spring unit consisting of at least a soft spring made from steel material.

In order to achieve above purposes, it is a spring unit consisting of at least a hard spring having number of convolution smaller than medium hard spring and soft spring and that can be in range from 5 to 10.

In order to achieve above purposes, it is a spring unit consisting of at least a hard spring made from steel material.

In order to achieve above purposes, the invention is a spring unit consisting of at least a soft spring, at least a medium hard spring and at least a hard spring, which are located in order, fitting different comfort levels along length of said spring unit.

### BRIEF DESCRIPTION OF THE DRAWINGS

FIG. 1 is a front perspective view of the spring unit being subject of the invention,

FIG. 2 is a view of soft spring located inside spring unit of the invention.

FIG. 3 is a view of medium hard spring located inside spring unit of the invention.

FIG. 4 is a view of hard spring located inside spring unit of the invention.

FIG. 5 is a graphic showing pressure distribution of pocket spring unit of the invention under 30% and 45% pressure, produced from spring strips by step by step changing number of convolution of springs of 1.80 mm wire diameter.

FIG. 6 is a graphic showing pressure distribution of five comfort zone spring unit of current art under 30% and 45% pressure produced by use of springs of 2.00 mm and 1.80 mm wire diameters.

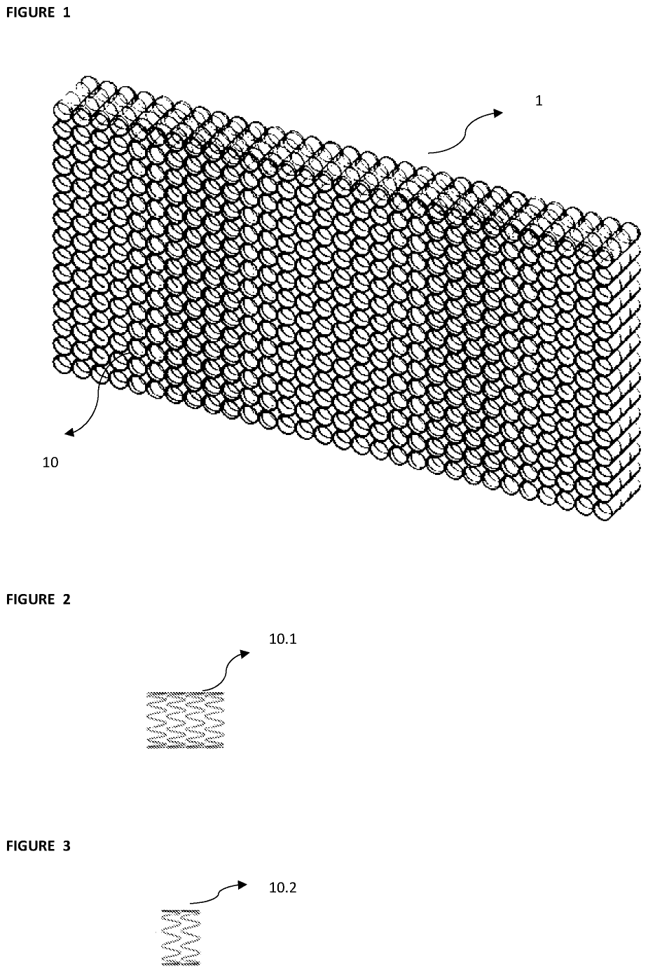

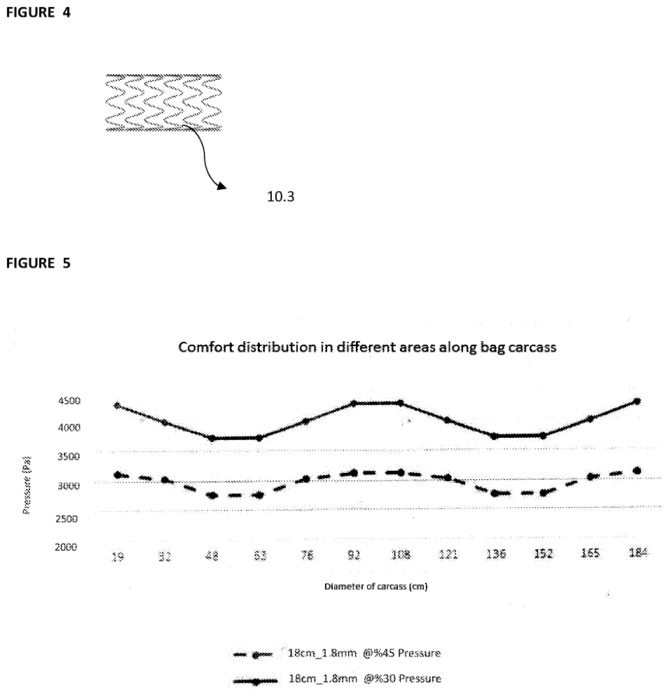

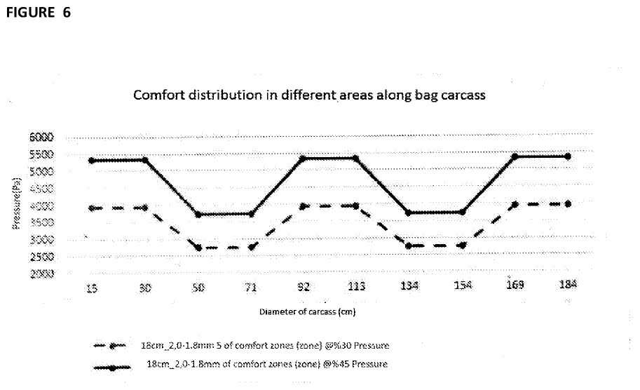

### DESCRIPTION OF PART REFERENCES

1. Spring unit
   10. Spring system
      10.1 soft spring
      10.2. medium hard spring
      10.3 hard spring

The drawings are not necessarily to be scaled and the details not necessary for understanding the present invention might have been neglected. In addition, the components which are equivalent to great extent at least or have equivalent functions at least have been assigned the same number.

### DETAILED DESCRIPTION OF THE INVENTION

In this detailed description, the preferred embodiments of the invention have been described in a manner not forming any restrictive effect but only for purpose of better understanding of the matter.

The spring unit (1) disclosed under the invention used in bed, armchairs and sofa like constructions and wherein different hardness and comfort levels in different areas are provided by springs of same wire diameter size and different convolution numbers and consist of nonwoven located inside the spring system (10).

Said spring system (10) consists of at least a soft spring (10.1), at least a medium hard spring (10.2) and at least a hard spring (10.3) having different number of convolution in comparison to single wire diameter and hardness intended to be obtained.

Said soft spring (10.1) is made from steel material and has a number of convolution between 7 and 12, preferably 8 and constitutes comfort area of spring unit (1) having low hardness (soft), and has higher number of convolution when compared to other springs.

Said medium hard spring (10.2) is made from steel and has number of convolution between 6 to 11, preferably 7. It provides transition between soft comfort areas and hard comfort areas of the spring unit (1) and is of same wire diameter as springs forming other comfort areas have. Number of convolution is such that it corresponds to average of number of turning of springs forming other comfort areas. It makes spring unit ergonomic by providing gradual comfort area transition between different comfort areas of the spring unit (1).

Said hard spring (10.3) is made from steel material and has a number of convolution between 5 and 10, preferably 6 and constitutes hard comfort area of spring unit (1), and has less number of convolution when compared to other springs.

The spring unit (1) disclosed under the invention provides different hardness and comfort levels in different areas of spring system (10) formed by springs of single wire diameter by gradually changing number of convolution of spring and thus bringing the obtained spring strips together.

Soft springs (10.1), medium hard springs (10.2) and hard springs (10.3) of said spring unit (1) are assembled along length of the spring unit (1) and thus different comfort areas are obtained.

By use of spring machines having servo motor controlling capability, initially hard springs (10.3) produced by increasing pretension where number of convolution is low, then number of convolution is increased one step and thus medium hard springs (10.2) are produced and then soft springs (10.1) with high number of convolution and decreasing pretension are produced and thus spring system (10) consisting of springs placed inside nonwoven is obtained. Spring groups (10.1 and 10.3) of different hardness in spring system (10) are provided by placing medium hard springs (10.2) providing formation of transition comfort between them and repeating said operation.

High pretension hard springs (10.3) having lower number of convolution are placed in front of the sequence to feed the assembling machine in the pocket spring unit produced in this way.

Spring system (10) in length corresponding to length of spring unit (1) are assembled in width direction of the spring unit (1) by adding hot melted glue to the center and/or to bottom and top by use of additional nonwoven in the assembling machine and thus produced with different comfort area and gradual transition between comfort areas.

Method for production of spring system (10) disclosed under the invention consists of process steps of
production of springs (10.1-10.2-10.3) from steel wire to form spring unit (1) at spring machine and placement into nonwoven and bringing into spring strips,
While forming spring strips, production of hard springs (10.3) in each line, in lower number of convolution with same wire diameter and increasing pretension to obtain hard comfort area of the spring unit (1),
Number of convolution is increased one step continuing medium hard springs (10.2) and forming transition comfort area in the spring unit (1) and thus production of next soft springs (10.1) in number of convolution with same wire diameter and less pretension in order to obtain soft comfort area,
Repeating mentioned different comfort areas along spring strip in a manner transition comfort area occurs between them
Feeding spring strips produced at spring machine to assembling machine in a manner springs of high hardness are in the beginning
Obtaining different comfort areas by gluing pocket spring strips to each other from centre at assembling machine by adding hot melted glue and/or from bottom and top by adding nonwoven, and providing gradual transition between comfort areas.

In a preferred embodiment of the invention, gluing pocket spring strips to each other at assembling machine from centre and/or from bottom and top by adding interlining is made by hot melt glue system.

1. A spring unit used in bed, armchair and sofa like constructions and realizing adjustment of different hardness and comfort levels in different areas of said constructions characterized in comprising:
at least a soft spring of one single wire diameter forming soft comfort area of low hardness area of said spring unit;
at least a medium hard spring providing gradual transition between soft comfort areas of said spring unit and hard comfort areas with a spring having number of convolution different from said soft spring and of same wire diameter;
a spring system comprising at least a hard spring providing hard comfort area of said spring unit by means of a spring having number of convolution different from spring of soft spring and medium hard spring and of same wire diameter as said medium hard spring and said soft spring.

2. A spring unit according to claim 1, characterized in comprising at least a medium hard spring having number of convolution smaller than soft spring and bigger than hard spring and which can be in range from 6 to 11.

3. A spring unit according to claim 2, characterized in comprising at least a medium hard spring made from steel material.

4. A spring unit according to claim 1, characterized in comprising at least a soft spring having number of convolution bigger than medium hard spring and hard spring and that can be in range from 7 to 12.

5. A spring unit according to claim 4, characterized in comprising at least a soft spring made from steel material.

6. A spring unit according to claim 1, characterized in comprising at least a hard spring having number of convolution smaller than medium hard spring and soft spring and that can be in range from 5 to 10.

7. A spring unit according to claim 6, characterized in comprising at least a hard spring made from steel material.

8. A spring unit according to claim 1, characterized in comprising at least a soft spring located in proper order fitting different comfort levels along length of said carcass, at least a medium hard spring and at least a hard spring.

9. A method for production of a spring system characterized in comprising the following steps:
production of springs from steel wire to form a spring unit at spring machine and placement into nonwoven and bringing into spring strips;
while forming spring strips, production of hard springs in each line, in lower number of convolution with same wire diameter and increasing pretension in order to obtain hard comfort area in spring unit;
number of convolution is increased one step continuing medium hard springs and forming transition comfort area in the spring unit and thus production of next soft springs in higher number of convolution with same wire diameter and less pretension in order to obtain soft comfort area;
repeating mentioned different comfort areas along spring strip in a manner transition comfort area occurs between them;
feeding spring strips produced at spring machine to assembling machine in a manner high hard springs are in the beginning of strip;
obtaining different comfort areas by gluing pocket spring strips to each other from middle at assembling machine by adding hot melted glue and/or from bottom and top by adding nonwoven, and providing gradual transition between comfort areas.
